(19) United States
(12) Patent Application Publication
(10) Pub. No.: US 2026/0079457 A1
(43) Pub. Date: Mar. 19, 2026

(54) DRIVING PLANNING METHOD FOR HIGH-VELOCITY MOTION MECHANISM

(71) Applicant: GUANGDONG UNIVERSITY OF TECHNOLOGY, Guangzhou (CN)

(72) Inventors: Lanyu ZHANG, Guangzhou (CN); Haotao LIN, Guangzhou (CN); Fuyuan FENG, Guangzhou (CN); Jian GAO, Guangzhou (CN)

(21) Appl. No.: 19/399,239

(22) Filed: Nov. 24, 2025

Related U.S. Application Data
(63) Continuation of application No. PCT/CN2025/103457, filed on Jun. 25, 2025.

(30) Foreign Application Priority Data
Sep. 9, 2024 (CN) 202411253047.9

(51) Int. Cl. G05B 13/04

(52) U.S. Cl. CPC G05B 13/042

(57) ABSTRACT

Provided is a driving planning method for a high-velocity motion mechanism, and the driving planning method comprises planning a first driving stage and a second driving stage which are continuous according to a maximum overshoot and an oscillation duration of inertial oscillation, the first driving stage being a high-velocity and high-acceleration motion driving stage; and the second driving stage being a dynamic low-velocity and low-acceleration S-shaped curve driving stage. According to the invention, a rapid motion is still achieved in the first driving stage, which ensures high efficiency of a motion process; a certain interval is set, which avoids overshooting and continuous oscillation at a positioning target generated by a high-velocity and large-inertia motion, and avoids the positioning target from being impacted or damaged by the motion mechanism.

### CROSS-REFERENCE TO RELATED APPLICATIONS

This application is a continuation of International Patent Application No. PCT/CN2025/103457 with a filing date of Jun. 25, 2025, designating the United States, now pending, and further claims priority to Chinese Patent Application No. 202411253047.9 with a filing date of Sep. 9, 2024. The DAS code for the priority application is B9D3. The content of the aforementioned applications, including any intervening amendments thereto, are incorporated herein by reference.

### TECHNICAL FIELD

The present invention relates to the technical field of driving planning, in particular to a driving planning method for a high-velocity motion mechanism

### BACKGROUND OF THE PRESENT INVENTION

With the increasing requirements for quality and efficiency in manufacturing, machining and positioning operations, higher requirements for high-performance positioning operations are put forward for a motion actuator. On one hand, a motion mechanism needs to undertake a higher-velocity and high-acceleration motion task, so as to achieve a rapid motion and ensure operation efficiency; and on the other hand, the motion mechanism cannot produce positioning overshooting, which avoids a product in a positioning target from being damaged by an inertial impact and continuous oscillation. In addition, it is also necessary to achieve high-accuracy positioning.

It is very difficult to meet these three requirements at the same time, it is difficult to avoid overshooting due to an inertial impact of positioning at a high velocity, and a large inertial oscillation may also affect the positioning accuracy, so that how to achieve high-velocity and high-acceleration positioning without overshooting is a difficult problem. Conventional high-velocity motion planning methods adopt direct one-time driving from an initial point to a target point, such as a method of step command+tracking differentiator, a method of trapezoidal curve and a method of S-shaped curve.

However, in an actual operation, there are high requirements for indexes such as a displacement, a velocity and an acceleration, so that the method of step command+tracking differentiator is only suitable for a situation that quality and efficiency requirements for a machining process are not high; and secondly, although the method of trapezoidal curve considers the velocity, the acceleration and the problem of low platform computing force, there is still a sudden acceleration jump or jitter phenomenon during the motion. However, in the high-velocity motion planning methods such as the method of S-shaped curve, a geometric smoothness of a motion curve is ensured by further restricting a maximum acceleration, a maximum velocity, a maximum jerk and other indexes.

Therefore, the prior art has a great influence of inertial energy under a high-velocity motion, and it is still unable to avoid excessive residual oscillation and needs a long attenuation time to meet a precise positioning requirement under a high-velocity and high-acceleration condition such as high-velocity starting and stopping.

### SUMMARY OF THE PRESENT INVENTION

Aiming at the defects in the prior art, the present invention provides a driving planning method for a high-velocity motion mechanism, and the driving planning method comprises planning two driving stages, which avoids a positioning target from being impacted or damaged by the motion mechanism while ensuring high efficiency of a motion process, and can ensure to avoid positioning accuracy from being affected by an inertial impact of a high-velocity motion, thereby achieving high-accuracy positioning.

The technical solution of the present invention is a driving planning method for a high-velocity motion mechanism, and the driving planning method comprises the following step of:
planning two continuous driving stages which are a first driving stage and a second driving stage respectively according to a maximum overshoot and an oscillation duration of inertial oscillation; wherein, the first driving stage is a high-velocity and high-acceleration motion driving stage; and the second driving stage is a dynamic low-velocity and low-acceleration S-shaped curve driving stage, and a final positioning target is reached through the dynamic low-velocity and low-acceleration S-shaped curve second driving stage;
a certain interval D₂ is maintained between a target displacement D₁ of the first driving stage and the final positioning target D; and
a starting time of the second driving stage refers to a moment when a real-time velocity in inertial oscillation in a positioning stage of the first driving stage is close to zero for the first time and a first inertial oscillation amplitude is close to an amplitude peak.

Preferably, the interval D₂ is determined through a maximum overshoot Oᵥ generated in the first driving stage and a set displacement protection margin Pₘ, so as to accommodate overshooting caused by a high-velocity motion, thereby avoiding the final target from being interfered by overshooting and oscillation.

Preferably, the initial motion planning parameters in the S-shaped curve of the second driving stage are determined through outputs of the first driving stage.

Preferably, the outputs of the first driving stage comprise the maximum overshoot of the first driving stage and the oscillation duration from ending of the first driving stage to stabilization of motion.

Preferably, initial motion planning parameters in the S-shaped curve of the second driving stage comprise an initial target displacement D₂, an initial maximum velocity V₂ₘₐₓ and an initial maximum acceleration A₂ₘₐₓ of the second driving stage.

Preferably, the initial maximum velocity V₂ₘₐₓ of the second driving stage is determined according to a remaining planned displacement and an oscillation duration of the first driving stage, and the initial maximum acceleration A₂ₘₐₓ of the second driving stage is calculated by using the initial maximum velocity V₂ₘₐₓ of the second driving stage and the oscillation duration of the first driving stage.

Preferably, in the second driving stage, through a physical constraint, a positioning error constraint and an optimized objective function, motion planning parameters corresponding to minimum overshoot and operation time of the second driving stage are optimized by continuous iteration.

Preferably, an iteration process for the motion planning parameters of the second driving stage specifically comprises the following steps:
S21) giving ranges for the planning parameters of the first driving stage and the second driving stage first to apply the physical constraint to parameter iteration, and initializing and assigning the planning parameters;
S22) substituting the planning parameters into a planning curve, applying the positioning error constraint to an actual motion, calculating the operation time Si and the maximum overshoot Oᵥ from an initial position to a position entering a stable state, and making the operation time Sₜ and the maximum overshoot Oᵥ form the optimized objective function:

$$fitness ( i ) = Min ( a \times {s}_{t} + b \times {O}_{v} ) ;$$

wherein, a and b are weight parameters of the operation time Sₜ and the maximum overshoot Oᵥ respectively.

S23) judging a number of iteration times and the objective function, when the number of iteration times and the objective function meet requirements, breaking out the iteration, and when the number of iteration times and the objective function do not meet the requirements, updating the parameters and repeating the step S22); and

S24) when the number of iteration times, the overshoot and the operation time meet the requirements, stopping the iteration, and outputting optimal planning parameters.

Preferably, according to the final positioning target D and restriction requirements for motion velocity, acceleration and jerk parameters, the planning parameters are optimized and set by using a system point-to-point motion response law, and the maximum velocity V₁ₘₐₓ, the maximum acceleration A₁ₘₐₓ and the maximum jerk J₁ₘₐₓ of the first driving stage are calculated; and the maximum velocity V₁ₘₐₓ, the maximum acceleration A₁ₘₐₓ and the maximum jerk J₁ₘₐₓ are taken as restriction conditions of the first driving stage, and the high-velocity motion stage is planned according to a point-to-point motion.

The present invention has the beneficial effects as follows:
1. according to the present invention, the motion planning of the high-velocity motion mechanism is divided into two driving stages, and the high-velocity and high-acceleration motion is adopted in the first driving stage, so that a rapid motion is still achieved, which ensures high efficiency of a motion process; and one interval is set between the first driving stage and the final target, which avoids overshooting and continuous oscillation at the positioning target generated by the high-velocity and large-inertia motion, and avoids the positioning target from being impacted or damaged by the motion mechanism;
2. according to the present invention, the S-shaped curve of low-velocity and low-acceleration motion is adopted in the second driving stage to reach the positioning target, the positioning target is reached at a low velocity, which can avoid overshooting and inertial oscillation at the final target, a low-velocity driving value at the starting time is set for the second driving stage planned, which can ensure that the inertial oscillation of the first driving stage will not interfere with the final target during the second driving stage, and the motion mechanism reaches the positioning target at a low velocity through the second driving stage, which can ensure to avoid positioning accuracy from being affected by an inertial impact of a high-velocity motion, thereby achieving high-accuracy positioning;
3. according to the present invention, the starting time is planned for the second driving stage through the overshoot and a stabilization time of the inertial oscillation of the first driving stage, so that the target can be reached at the end of the inertial oscillation of the first driving stage, and whole positioning operation time is not prolonged, thereby ensuring high efficiency of whole operation;
4. according to the present invention, the optimal motion planning parameters of the second driving stage are automatically found through the maximum overshoot and operation time of the first driving stage by iteration, thereby improving practicability and dynamism of the present invention; and
5. according to the present invention, the physical constraint, the positioning error constraint and time optimal planning of planning curve design are integrated, so that the planning parameters corresponding to a motion effect with the minimum overshoot and operation time can be automatically iterated, and the algorithm is simple and suitable for various numerical control machine tools.

### DESCRIPTION OF THE DRAWINGS

FIG. 1 is a flow chart of a method in the present invention; and

FIG. 2 is a flow chart of iteration of motion planning parameters of a second driving stage in the present invention.

### DETAILED DESCRIPTION OF PREFERRED EMBODIMENTS

Specific embodiments of the present invention are further described hereinafter with reference to the drawings.

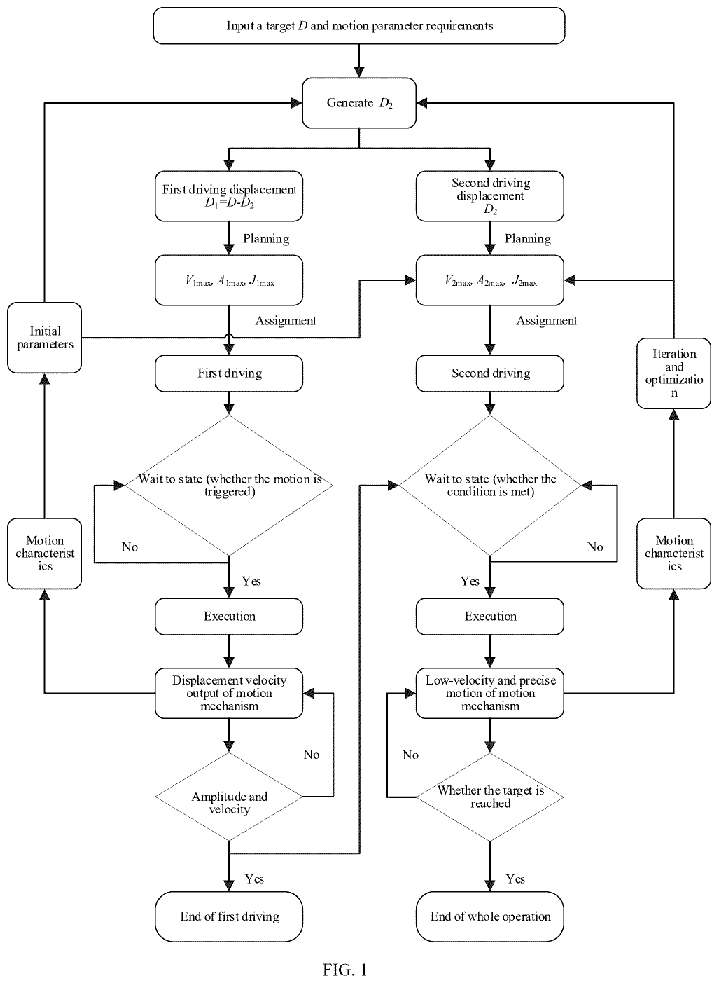

As shown in FIG. 1, the embodiment provides a driving planning method for a high-velocity motion mechanism, which comprises:

planning two continuous driving stages which are a first driving stage and a second driving stage respectively according to a maximum overshoot and an oscillation duration of inertial oscillation.

The first driving stage is a high-velocity and high-acceleration motion driving stage; and the second driving stage is a dynamic low-velocity and low-acceleration S-shaped curve driving stage, and a final positioning target is reached through the dynamic low-velocity and low-acceleration S-shaped curve second driving stage.

In the embodiment, in order to avoid overshooting and continuous oscillation at the positioning target generated by the high-velocity and large-inertia motion, and avoid the positioning target from being impacted or damaged by the motion mechanism, a certain interval D₂ is maintained between a target displacement D₁ of the first driving stage and the final positioning target D. In the embodiment, the interval D₂ is determined through a maximum overshoot Oᵥ generated in the first driving stage and a set displacement protection margin Pₘ, so as to accommodate overshooting caused by a high-velocity motion, thereby avoiding the final target from being interfered by overshooting and oscillation.

In the embodiment, a starting time of the second driving stage refers to a moment when a real-time velocity in inertial oscillation in a positioning stage of the first driving stage is close to zero for the first time and a first inertial oscillation amplitude is close to an amplitude peak.

Preferably, in the embodiment, in the first driving stage, according to the final positioning target D) and restriction requirements for motion velocity, acceleration and jerk parameters, the planning parameters are optimized and set by using a system point-to-point motion response law, and the target displacement D₁, the maximum velocity V₁ₘₐₓ, the maximum acceleration A₁ₘₐₓ and the maximum jerk J₁ₘₐₓ of the first driving stage are calculated; and the maximum velocity V₁ₘₐₓ, the maximum acceleration A₁ₘₐₓ and the maximum jerk J₁ₘₐₓ are taken as restriction conditions of the first driving stage, and the high-velocity motion stage is planned according to a point-to-point motion.

Preferably, in the embodiment, initial motion planning parameters in the S-shaped curve of the second driving stage comprise an initial target displacement D₂, an initial maximum velocity V₂ₘₐₓ and an initial maximum acceleration A₂ₘₐₓ of the second driving stage. Moreover, the initial maximum velocity V₂ₘₐₓ of the second driving stage is determined according to a remaining planned displacement and an oscillation duration of the first driving stage, and the initial maximum acceleration A₂ₘₐₓ of the second driving stage is calculated by using the initial maximum velocity V₂ₘₐₓ of the second driving stage and the oscillation duration of the first driving stage.

Preferably, in the embodiment, the initial target displacement D₂ of the second driving stage, the initial maximum velocity V₂ₘₐₓ of the second driving stage and the initial maximum acceleration A₂ₘₐₓ of the second driving stage before iteration are obtained by the following formula:

$$\{ \begin{matrix}{D}_{2} = {O}_{v} + {P}_{m} \\ {V}_{2 max} = \frac{2 \times {D}_{2}}{{S}_{t}} \\ {A}_{2 max} = \frac{4 \times {V}_{2 max}}{{S}_{t}}\end{matrix} ;$$

wherein, Oᵥ is the maximum overshoot of the first driving stage; Pₘ is the protection margin set for the second driving stage; and Sₜ is the oscillation duration from ending of the first driving stage to stabilization of motion.

Preferably, in the embodiment, in the second driving stage, through a physical constraint, a positioning error constraint and an optimized objective function, motion planning parameters corresponding to minimum overshoot and operation time of the second driving stage are optimized by continuous iteration.

The physical constraint of the second driving stage is as follows:

$$\{ \begin{matrix}{A}_{1 max} , {A}_{2 max} < {A}_{max} \\ {V}_{1 max} , {V}_{2 max} < {V}_{max} \\ {J}_{1 max} , {J}_{2 max} < {J}_{max} \\ {D}_{2 min} = 2 \frac{{V}_{2 max}^{2}}{{A}_{2 max}^{2}} \leq D - {D}_{1}\end{matrix} ;$$

wherein, A₁ₘₐₓ and A₂ₘₐₓ are planned maximum accelerations of the first driving stage and the second driving stage set in planning respectively; Vₘₐₓ, Aₘₐₓ and Jₘₐₓ are a maximum velocity, a maximum acceleration and a maximum jerk under physical characteristics of the mechanism respectively; V₁ₘₐₓ and V₂ₘₐₓ are maximum velocities of the first driving stage and the second driving stage set in planning respectively; J₁ₘₐₓ and J₂ₘₐₓ are maximum jerks of the first driving stage and the second driving stage set in planning; D represents the final positioning target, D₁ represents the positioning target displacement of the first driving stage, and D₂ min is a minimum positioning target displacement of the second driving stage under planning parameters.

The positioning error constraint of the second driving stage refers to a positioning error constraint on an actual position change y(t) by setting a positioning accuracy δ:

$$\vert y ( t ) - ( {D}_{1} + {D}_{2} ) \vert \leq δ ;$$

wherein, D₁ and D₂ are the target displacement of the first driving stage and the target displacement of the second driving stage respectively.

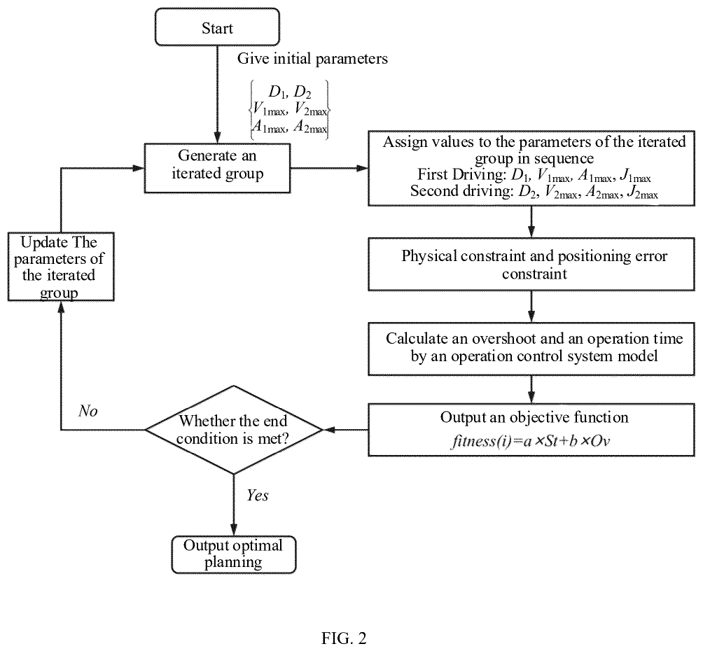

Preferably, in the embodiment, as shown in FIG. 2, an iteration process for the motion planning parameters of the second driving stage specifically comprises the following steps:
S21) giving ranges for the planning parameters of the first driving stage and the second driving stage first to apply the physical constraint to parameter iteration, and initializing and assigning the planning parameters;
S22) substituting the planning parameters into a planning curve, applying the positioning error constraint to an actual motion, calculating the operation time Sₜ and the maximum overshoot Oᵥ from an initial position to a position entering a stable state, and making the operation time Sₜ and the maximum overshoot Oᵥ form the optimized objective function:

$$fitness ( i ) = Min ( a \times {s}_{t} + b \times {O}_{v} ) ;$$

wherein, a and b are weight parameters of the operation time Sₜ and the maximum overshoot Oᵥ respectively;
S23) judging a number of iteration times and the objective function, when the number of iteration times and the objective function meet requirements, breaking out the iteration, and when the number of iteration times and the objective function do not meet the requirements, updating the parameters and repeating the step S22); and
S24) when the number of iteration times, the overshoot and the operation time meet the requirements, stopping the iteration, and outputting optimal planning parameters.

The descriptions in the above embodiments and the specification only illustrate the principles and the optimal embodiments of the present invention, the present invention may have various changes and improvements without departing from the spirit and scope of the present invention, and the changes and improvements fall within the scope sought to be protected by the present invention.

We claim:

1. A driving planning method for a high-velocity motion mechanism, wherein the driving planning method comprises planning a first driving stage and a second driving stage which are continuous according to a maximum overshoot and an oscillation duration of inertial oscillation; wherein,
the first driving stage is a high-velocity and high-acceleration motion driving stage; and the second driving stage is a dynamic low-velocity and low-acceleration S-shaped curve driving stage, and a final positioning target is reached through the dynamic low-velocity and low-acceleration S-shaped curve second driving stage;
an interval D₂ is maintained between a target displacement D₁ of the first driving stage and the final positioning target D;
a starting time of the second driving stage refers to a moment when a real-time velocity in inertial oscillation in a positioning stage of the first driving stage is close to zero for the first time and a first inertial oscillation amplitude is close to an amplitude peak; and
initial motion planning parameters in the low-acceleration S-shaped curve of the second driving stage comprise an initial target displacement D₂, an initial maximum velocity V₂ₘₐₓ and an initial maximum acceleration A₂ₘₐₓ of the second driving stage;
wherein, the initial maximum velocity V₂ₘₐₓ of the second driving stage is determined according to a remaining planned displacement and an oscillation duration of the first driving stage, and the initial maximum acceleration A₂ₘₐₓ of the second driving stage is calculated by using the initial maximum velocity V₂ₘₐₓ of the second driving stage and the oscillation duration of the first driving stage.

2. The driving planning method for the high-velocity motion mechanism according to claim 1, wherein the interval D₂ is determined through a maximum overshoot Oᵥ generated in the first driving stage and a set displacement protection margin Pₘ.

3. The driving planning method for the high-velocity motion mechanism according to claim 1, wherein the initial motion planning parameters in the S-shaped curve of the second driving stage are determined through outputs of the first driving stage; and the outputs of the first driving stage comprise the maximum overshoot of the first driving stage and the oscillation duration from ending of the first driving stage to stabilization of motion.

4. The driving planning method for the high-velocity motion mechanism according to claim 1, wherein the initial target displacement D₂ of the second driving stage, the initial maximum velocity V₂ₘₐₓ of the second driving stage and the initial maximum acceleration A₂ₘₐₓ of the second driving stage are obtained by the following formula:
$$\{ \begin{matrix}{D}_{2} = {O}_{v} + {P}_{m} \\ {V}_{2 max} = \frac{2 \times {D}_{2}}{{S}_{t}} \\ {A}_{2 max} = \frac{4 \times {V}_{2 max}}{{S}_{t}}\end{matrix} ;$$
wherein, Oᵥ is the maximum overshoot of the first driving stage; Pₘ is the protection margin set for the second driving stage; and Sₜ is the oscillation duration from ending of the first driving stage to stabilization of motion.

5. The driving planning method for the high-velocity motion mechanism according to claim 1, wherein, in the second driving stage, through a physical constraint, a positioning error constraint and an optimized objective function, motion planning parameters corresponding to minimum overshoot and operation time of the second driving stage are optimized by continuous iteration.

6. The driving planning method for the high-velocity motion mechanism according to claim 5, wherein the physical constraint of the second driving stage is as follows:
$$\{ \begin{matrix}{A}_{1 max} , {A}_{2 max} < {A}_{max} \\ {V}_{1 max} , {V}_{2 max} < {V}_{max} \\ {J}_{1 max} , {J}_{2 max} < {J}_{max} \\ {D}_{2 min} = 2 \frac{{V}_{2 max}^{2}}{{A}_{2 max}^{2}} \leq D - {D}_{1}\end{matrix} ;$$
wherein A₁ₘₐₓ and A₂ₘₐₓ are planned maximum accelerations of the first driving stage and the second driving stage set in planning respectively; Vₘₐₓ, Aₘₐₓ and Jₘₐₓ are a maximum velocity, a maximum acceleration and a maximum jerk under physical characteristics of the mechanism respectively; V₁ₘₐₓ and I₂ₘₐₓ are maximum velocities of the first driving stage and the second driving stage set in planning respectively; J₁ₘₐₓ and J₂ₘₐₓ are maximum jerks of the first driving stage and the second driving stage set in planning; D represents the final positioning target, D₁ represents the positioning target displacement of the first driving stage, and D₂ min is a minimum positioning target displacement of the second driving stage under planning parameters.

7. The driving planning method for the high-velocity motion mechanism according to claim 5, wherein the positioning error constraint of the second driving stage refers to a positioning error constraint on an actual position change y(t) by setting a positioning accuracy δ:
$$\vert y ( t ) - ( {D}_{1} + {D}_{2} ) \vert \leq δ ;$$
wherein, D₁ and D₂ are the target displacement of the first driving stage and the target displacement of the second driving stage respectively.

8. The driving planning method for the high-velocity motion mechanism according to claim 5, wherein the optimized objective function is as follows:
$$fitness ( i ) = Min ( a \times {s}_{t} + b \times {O}_{v} ) ;$$
wherein, a and b are weight parameters of the operation time Sₜ and the maximum overshoot Oᵥ respectively.

9. The driving planning method for the high-velocity motion mechanism according to claim 5, wherein an iteration process for the motion planning parameters of the second driving stage specifically comprises the following steps:
S21) giving ranges for the planning parameters of the first driving stage and the second driving stage first to apply the physical constraint to parameter iteration, and initializing and assigning the planning parameters;
S22) substituting the planning parameters into a planning curve, applying the positioning error constraint to an actual motion, calculating the operation time Sₜ and the maximum overshoot Oᵥ from an initial position to a position entering a stable state, and making the operation time Sₜ and the maximum overshoot Oᵥ form the optimized objective function;
S23) judging a number of iteration times and the objective function, when the number of iteration times and the objective function meet requirements, breaking out the iteration, and when the number of iteration times and the objective function do not meet the requirements, updating the parameters and repeating the step S22); and
S24) when the number of iteration times, the overshoot and the operation time meet the requirements, stopping the iteration, and outputting optimal planning parameters.

10. The driving planning method for the high-velocity motion mechanism according to claim 1, wherein, according to the final positioning target D and restriction requirements for motion velocity, acceleration and jerk parameters, the planning parameters are optimized and set by using a system point-to-point motion response law, and the target displacement D₁, the maximum velocity V₁ₘₐₓ, the maximum acceleration A₁ₘₐₓ and the maximum jerk J₁ₘₐₓ of the first driving stage are calculated; and the maximum velocity V₁ₘₐₓ, the maximum acceleration A₁ₘₐₓ and the maximum jerk J₁ₘₐₓ are taken as restriction conditions of the first driving stage, and the high-velocity motion stage is planned according to a point-to-point motion.
